(19) United States
(12) Patent Application Publication
(10) Pub. No.: US 2022/0055128 A1
(43) Pub. Date: Feb. 24, 2022

(54) RECIPROCATING SAW DRILL BIT

(71) Applicant: Jose Yanez, Henderson, NV (US)

(72) Inventor: Jose Yanez, Henderson, NV (US)

(21) Appl. No.: 17/188,403

(22) Filed: Mar. 1, 2021

Related U.S. Application Data
(60) Provisional application No. 62/984,659, filed on Mar. 3, 2020.

(51) Int. Cl. B23D 49/10

(52) U.S. Cl. CPC B23D 49/10

(57) ABSTRACT

According to various embodiments, a reciprocating saw drill bit is disclosed. The reciprocating saw drill bit includes a spindle with a first axis of rotation, a portion of the spindle defining a cylindrical section having a second axis, where the second axis is not parallel to the first axis. The reciprocating saw drill bit further includes a swashplate having a hole from a first surface of the swashplate to a second surface of the swashplate and a spherical portion having a center point positioned at a fixed distance normal to a centerline of the hole, the hole having an inner surface adapted to fit around an outer surface of the cylindrical section of the spindle. The reciprocating saw drill bit additionally includes a connecting rod, adapted to slide through at least one bushing, the connecting rod having a first end and a second end, the first end of the connecting rod being adapted to connect to the spherical portion of the swashplate via a ball-and-socket/slider joint hybrid, the second end adapted to connect to a removable blade.

### CROSS-REFERENCE TO RELATED APPLICATIONS

This application claims priority to provisional application 62/984,659, filed Mar. 3, 2020, which is herein incorporated by reference in its entirety.

### FIELD OF THE INVENTION

The present invention relates generally to electronic hand tools and, more particularly, to a reciprocating saw drill bit adapted for an electric drill/driver.

### BACKGROUND OF THE INVENTION

Millions of handymen, electricians, contractors, etc. have various tools they keep on them and consider essential. Efficiency increases with the number of tools carried on the person. With most blue-collar jobs, a fair amount of improvising is required when completing a job. Materials and parts must be adjusted to fit cohesively with everything else. There is often a need for a reciprocating saw but carrying the rather bulky device around everywhere is simply inconvenient and bothersome. As such, there is a need for an alternative to a typical reciprocating saw that is drastically lighter and smaller without affecting performance.

### SUMMARY OF THE INVENTION

According to various embodiments, a reciprocating saw drill bit is disclosed. The reciprocating saw drill bit includes a spindle with a first axis of rotation, a portion of the spindle defining a cylindrical section having a second axis, where the second axis is not parallel to the first axis. The reciprocating saw drill bit further includes a swashplate having a hole from a first surface of the swashplate to a second surface of the swashplate and a spherical portion having a center point positioned at a fixed distance normal to a centerline of the hole, the hole having an inner surface adapted to fit around an outer surface of the cylindrical section of the spindle. The reciprocating saw drill bit additionally includes a connecting rod, adapted to slide through at least one bushing, the connecting rod having a first end and a second end, the first end of the connecting rod being adapted to connect to the spherical portion of the swashplate via a ball-and-socket/slider joint hybrid, the second end adapted to connect to a removable blade.

According to various embodiments, a method for moving a blade in a reciprocating manner is disclosed. The method includes the steps of: attaching a blade to a connecting rod, the connecting rod operably connected to a spherical portion of a swashplate via a ball-and-socket/slider joint hybrid, the swashplate having a hole with an inner surface connected to an outer surface of a cylindrical section of a spindle, the cylindrical section having a central axis not parallel to the axis of rotation of the spindle; and causing the blade to move in a reciprocating manner by rotating the spindle.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1 depicts a rendering of a reciprocating saw drill bit device according to an embodiment of the invention;

FIG. 2 depicts a diagram of different viewpoints of the device 10 according to an embodiment of the invention;

FIG. 3 depicts a diagram of different viewpoints of the housing according to an embodiment of the present invention;

FIG. 4 depicts a rendering of the mechanisms for the reciprocating saw drill bit device 10 according to an embodiment of the present invention;

FIG. 5 depicts a diagram of different viewpoint of the mechanisms according to an embodiment of the present invention;

FIG. 6 depicts a diagram of different viewpoints of the swashplate according to an embodiment of the present invention;

FIG. 7 depicts a diagram of different viewpoints of the connecting rod according to an embodiment of the present invention; and

FIG. 8 depicts a diagram of different viewpoints of the bushings according to an embodiment of the present invention.

### DETAILED DESCRIPTION OF THE INVENTION

Generally disclosed herein are embodiments for an adaption of a reciprocating saw. A reciprocating saw drill bit conversion adapts typical mechanisms utilized in reciprocating saws with the availability of an electric drill/driver (the most essential tool of every skilled laborer). This is done so by outsourcing the powerhouse to the electric drill.

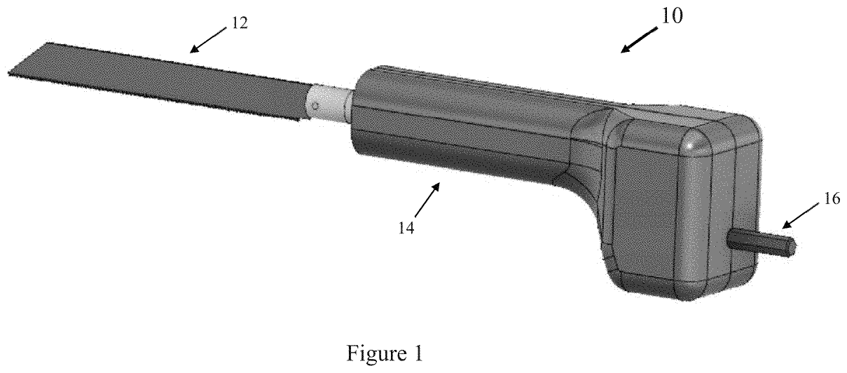

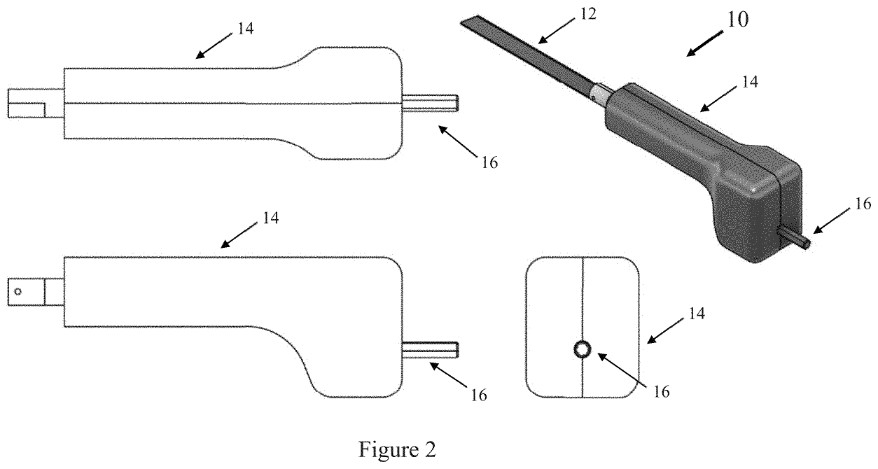

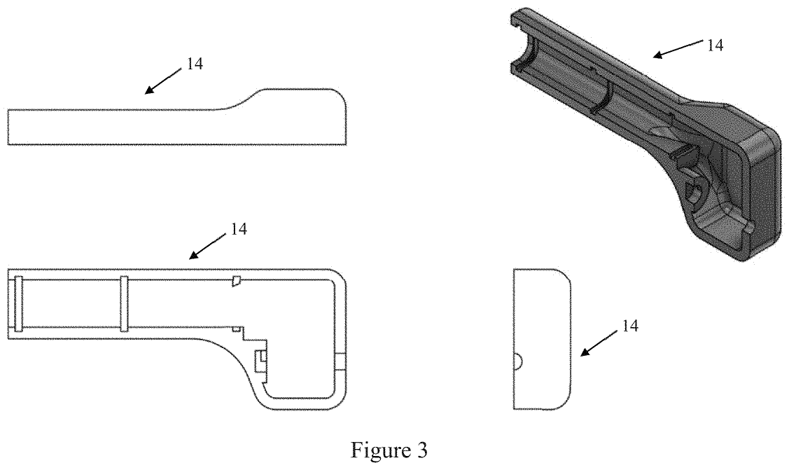

FIG. 1 depicts a rendering of a reciprocating saw drill bit device 10 according to an embodiment of the invention and FIG. 2 depicts a diagram of different viewpoints of the device 10 according to an embodiment of the invention. In operation, a blade 12 would be attached to the device 10. This blade 12 can be changed with different blades adapted for specific materials and/or purposes. For instance, blades specifically designed for cutting wood, plastic, and metals with different characteristics ranging from sheet metal to stainless steel, as nonlimiting examples, can be attached. The bulk of the device 10 is the housing 14 for the mechanisms, which also acts as the handle for the device 10. The housing 16 should be created out of a heat-resistant material to handle the thermal gradients generated by the friction of the moving parts. Two nonlimiting examples of viable material include Nylon-66 (PA-66) and glass fiber reinforced plastic. FIG. 3 depicts a diagram of different viewpoints of the housing 16 according to an embodiment of the present invention. The last important external component is the drill bit connection or drive shaft 16. The drill bit connection 16 can be manufactured using high speed steel (HSS) or material that possesses the similar strength and heat resistance. The drill bit connection 16 would be shaped as a quarter-inch hex shank (i.e., a shank with the cross-section of a hexagon measuring ¼ inch). This is an industry standard connection which would allow the device 10 to be compatible with most available impact drivers to provide the required powerhouse for motion conversion. The drill bit connection 16 is where the drill (not shown) attaches and provides the rotational motion which is converted by the mechanisms into reciprocating linear motion with the help of a swashplate.

The reciprocating saw drill bit device 10 would function as a compact version of a reciprocating saw. It would act as a simple tool that every laborer could always carry with them and bring out of the toolbox when needed. This is a much better alternative than that of a hand saw, which is exponentially more time inefficient.

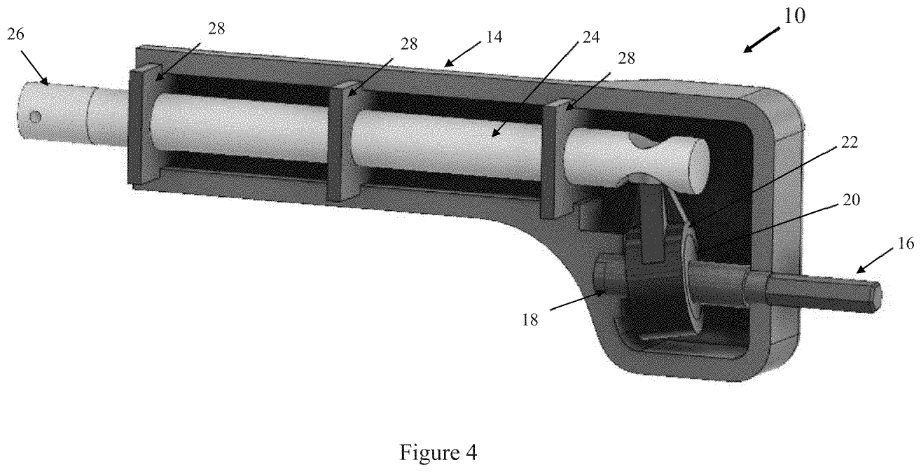

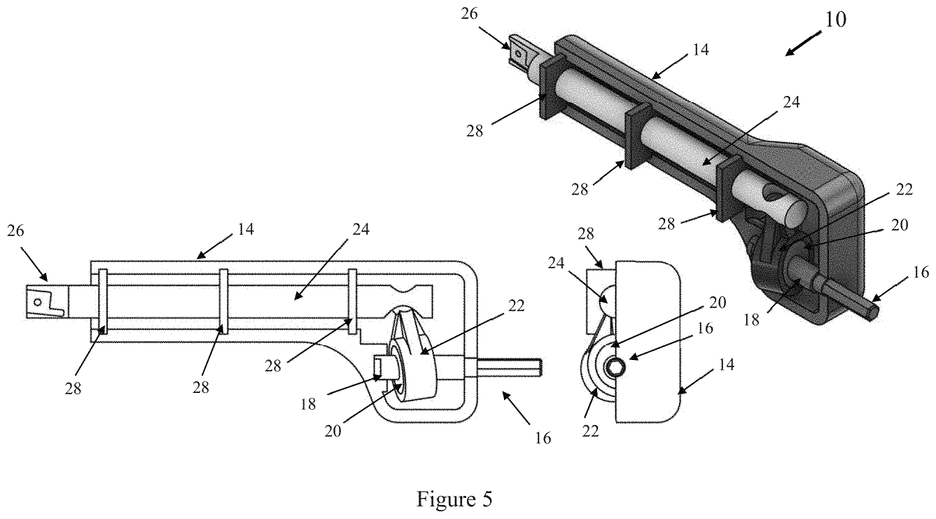

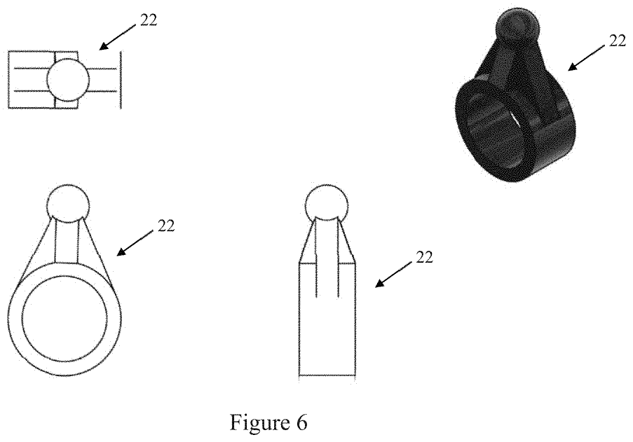

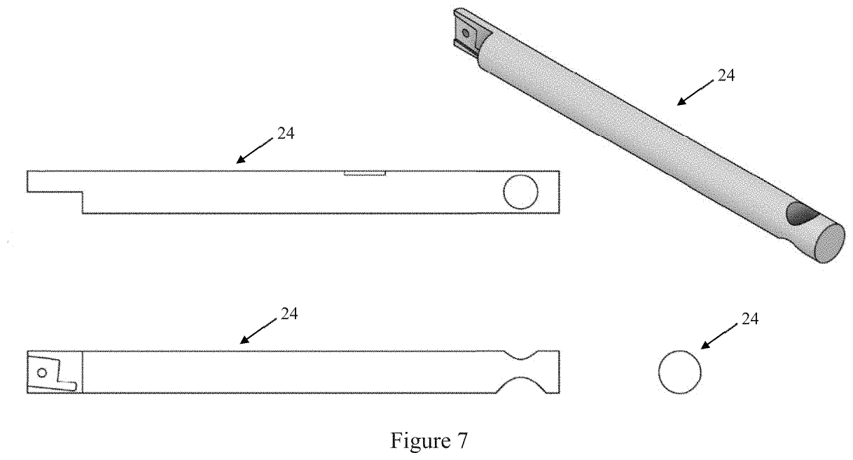

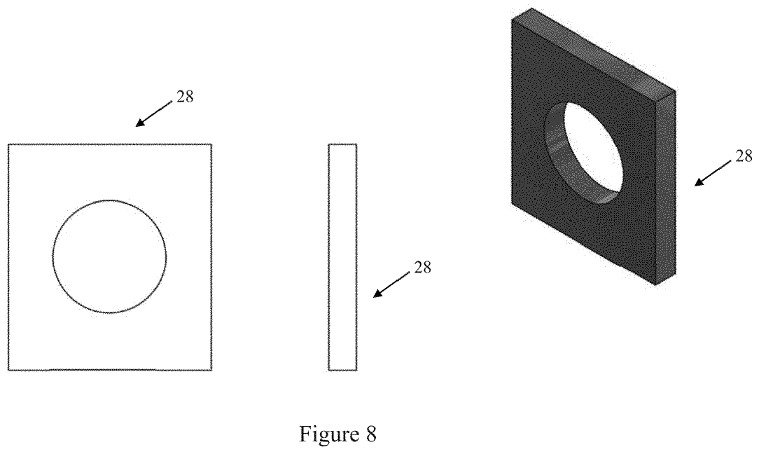

A key novelty that this invention introduces is the outsourcing of the powerhouse to an electric drill. FIG. 4 depicts a rendering of the mechanisms for the reciprocating saw drill bit device 10 according to an embodiment of the present invention and FIG. 5 depicts a diagram of different viewpoint of the mechanisms according to an embodiment of the present invention. The main driver is a spindle 18 with an embedded cylinder 20 that is slightly tilted. The angle of tilt can vary from anywhere between about five and thirty degrees. This cylinder 20 is responsible for translating the rotational motion onto a swash plate 22. The spindle 18 in turn moves the swashplate 22 around the cylinder 20 in a “wobbling motion”, which converts the rotational motion into reciprocating linear motion. By wobbling motion, what is being described is the rotation along the input shaft axis. As the cylinder 20 is not exactly centered and balanced but tilted, the result is a motion in which the cylinder 20 appears to be wobbling, similar to the way a coin wobbles as it is settling into a table after being spun. If a single point is referenced on the swashplate 22 the motion creates a sinusoidal pattern corresponding to the reciprocating motion needed for the blade 12 to serve its function. FIG. 6 depicts a diagram of different viewpoints of the swashplate according to an embodiment of the present invention. The swashplate 22 then moves the connecting rod 24, effectively driving the blade 12 in a reciprocating linear motion with torque provided from the drill, electric driver, or compact driver (not shown). The connecting rod 24 includes three main characteristics: (1) a spherical joint with the swashplate 22; (2) the blade housing 26 at the frontmost part of the rod; and (3) rotational restricting bearings that only allow the connecting rod 24 to move back and forth without rotation. FIG. 7 depicts a diagram of different viewpoints of the connecting rod according to an embodiment of the present invention. This swashplate 22 is connected to the connecting rod 24 via a ball-and-socket/slider joint hybrid. The ball-and-socket (spherical) joint described allows the swashplate 22 to rotate while maintaining connection to the connecting rod 24. This spherical joint would allow for a curved path to be formed. However, since the path of the connecting rod 24 is restricted to a linear path, the spherical joint is required to move vertically in order to not over-constrain the connecting rod 24. This joint hybrid allows for the connecting rod 24 to push back and forth the slider 26 which holds the blade 12 and performs the reciprocating motion. The slider or blade housing 26 allows the swashplate to push the connecting rod 24 back and forth which holds the blade 12 and performs the reciprocating motion. The connecting rod 24 is held in place by three bushings 28. The bushings 28 only need to be fitted into the housing 14. They are connected via precisely casted slots for the bushings 28 to fit into. Once the housing 14 is closed, the shape of the housing components restricts the motion of the bushings 28 in any direction.]. FIG. 8 depicts a diagram of different viewpoints of the bushings according to an embodiment of the present invention.

Due to the complex geometry of some of these components, a preferable means of production would be steel casting, molding, and machining. With this method, complex geometry could be easily created in a single solid piece, making the components stronger and more capable of handling the high-torque environment. Each component can be made of steel, though that is exemplary and not intended to be limiting. The housing 14 could be made out of Nylon-66 or fiberglass reinforced plastic, as nonlimiting examples. The bushings 28 could be made out of brass or steel, as nonlimiting examples. The main drive mechanisms: swashplate 22, connection rod 24, and hex shaft (drill bit connector) 16 should be made out of HSS or other metals with high strength and thermal resistance, as a nonlimiting example.

Although the main powerhouse is an electric drill (not shown), the device's main functionality come from the swashplate system which is in charge of converting the rotational motion from the electric drill to reciprocating-linear motion. Another reciprocating saw is that described in U.S. Pat. No. 7,797,841 (Moreno). However, Moreno requires an on-boarded powerhouse to provide rotational motion to create the reciprocating motion for the saw blade, which adds weight and bulkiness to the reciprocating saw. By contrast, embodiments disclosed herein include a drive shaft 16 compatible with standard compact driver/drills, allowing the driver/drill to serve as the powerhouse. Therefore, the powerhouse is outsourced which allows embodiments disclosed herein to be lightweight and less cumbersome.

As such, disclosed herein are embodiments for a reciprocating saw drill bit. The reciprocating saw drill bit includes a spindle with a first axis of rotation, a portion of the spindle defining a cylindrical section having a second axis, where the second axis is not parallel to the first axis. The reciprocating saw drill bit further includes a swashplate having a hole from a first surface of the swashplate to a second surface of the swashplate and a spherical portion having a center point positioned at a fixed distance normal to a centerline of the hole, the hole having an inner surface adapted to fit around an outer surface of the cylindrical section of the spindle. The reciprocating saw drill bit additionally includes a connecting rod, adapted to slide through at least one bushing, the connecting rod having a first end and a second end, the first end of the connecting rod being adapted to connect to the spherical portion of the swashplate via a ball-and-socket/slider joint hybrid, the second end adapted to connect to a removable blade.

The reciprocating saw drill bit may further include an outer housing configured to enclose the cylindrical portion of the spindle, the swashplate, the at least one bushing, and at least the first end of the connecting rod. The outer housing may be comprised of two pieces configured to fit together around the spindle, the swashplate, the at least one bushing, and at least the first end of the connecting rod. The connecting rod may be substantially cylindrical. The at least one bushing may have a square cross-section, with a circular hole extending from a first surface to a second surface, the circular hole defining an inner surface, the inner surface having an inner diameter that is at least as large as an outer diameter of the connecting rod. The reciprocating saw drill bit may include at least 3 bushings. The spherical portion of the swashplate may have a diameter that is less than the distance from the first surface to the second surface of the swashplate. The spindle, the swashplate, the at least one bushing, and the connecting rod may each be independently comprised of a metal. The spindle may be configured to rotate up to 3500 rpm. The stroke length of connecting rod may be less than 1.5 inches. The fixed distance may be between 1 and 3 inches.

Further disclosed herein are embodiments for a method for moving a blade in a reciprocating manner, including the steps of attaching a blade to a connecting rod, the connecting rod operably connected to a spherical portion of a swashplate via a ball-and-socket/slider joint hybrid, the swashplate having a hole with an inner surface connected to an outer surface of a cylindrical section of a spindle, the cylindrical section having a central axis not parallel to the axis of rotation of the spindle; and causing the blade to move in a reciprocating manner by rotating the spindle.

The connecting rod may be substantially cylindrical. The connecting rod may be positioned within at least one bushing, the at least one bushing having a square cross-section, with a circular hole extending from a first surface to a second surface, the circular hole defining an inner surface, the inner surface having an inner diameter that is at least as large as an outer diameter of the connecting rod. The connecting rod may be positioned within at least 3 bushings. The spherical portion of the swashplate may have a diameter that is less than the distance from a first surface to a second surface of the swashplate. The spindle, the swashplate, the at least one bushing, and the connecting rod may each be independently comprised of a metal. The spindle may rotate at up to 3500 rpm. The stroke length of the connecting rod may be less than 1.5 inches.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

What is claimed is:

1. A reciprocating saw drill bit, comprising:
a spindle with a first axis of rotation, a portion of the spindle defining a cylindrical section having a second axis, where the second axis is not parallel to the first axis;
a swashplate having a hole from a first surface of the swashplate to a second surface of the swashplate and a spherical portion having a center point positioned at a fixed distance normal to a centerline of the hole, the hole having an inner surface adapted to fit around an outer surface of the cylindrical section of the spindle; and
a connecting rod, adapted to slide through at least one bushing, the connecting rod having a first end and a second end, the first end of the connecting rod being adapted to connect to the spherical portion of the swashplate via a ball-and-socket/slider joint hybrid, the second end adapted to connect to a removable blade.

2. The reciprocating saw drill bit according to claim 1, further comprising an outer housing configured to enclose the cylindrical portion of the spindle, the swashplate, the at least one bushing, and at least the first end of the connecting rod.

3. The reciprocating saw drill bit according to claim 2, wherein the outer housing is comprised of two pieces configured to fit together around the spindle, the swashplate, the at least one bushing, and at least the first end of the connecting rod.

4. The reciprocating saw drill bit according to claim 1, wherein the connecting rod is substantially cylindrical.

5. The reciprocating saw drill bit according to claim 1, wherein the at least one bushing has a square cross-section, with a circular hole extending from a first surface to a second surface, the circular hole defining an inner surface, the inner surface having an inner diameter that is at least as large as an outer diameter of the connecting rod.

6. The reciprocating saw drill bit according to claim 1, wherein the reciprocating saw drill bit comprises at least 3 bushings.

7. The reciprocating saw drill bit according to claim 1, wherein the spherical portion of the swashplate has a diameter that is less than the distance from the first surface to the second surface of the swashplate.

8. The reciprocating saw drill bit according to claim 1, wherein the spindle, the swashplate, the at least one bushing, and the connecting rod are each independently comprised of a metal.

9. The reciprocating saw drill bit according to claim 1, wherein the spindle is configured to rotate up to 3500 rpm.

10. The reciprocating saw drill bit according to claim 1, wherein a stroke length of the connecting rod is less than 1.5 inches.

11. The reciprocating saw drill bit according to claim 1, wherein the fixed distance is between 1 and 3 inches.

12. A method for moving a blade in a reciprocating manner, comprising the steps of:
attaching a blade to a connecting rod, the connecting rod operably connected to a spherical portion of a swashplate via a ball-and-socket/slider joint hybrid, the swashplate having a hole with an inner surface connected to an outer surface of a cylindrical section of a spindle, the cylindrical section having a central axis not parallel to the axis of rotation of the spindle;
causing the blade to move in a reciprocating manner by rotating the spindle.

13. The method according to claim 12, wherein the connecting rod is substantially cylindrical.

14. The method according to claim 12, wherein the connecting rod is positioned within at least one bushing, the at least one bushing having a square cross-section, with a circular hole extending from a first surface to a second surface, the circular hole defining an inner surface, the inner surface having an inner diameter that is at least as large as an outer diameter of the connecting rod.

15. The method according to claim 12, wherein the connecting rod is positioned within at least 3 bushings.

16. The method according to claim 12, wherein the spherical portion of the swashplate has a diameter that is less than the distance from a first surface to a second surface of the swashplate.

17. The method according to claim 12, wherein the spindle, the swashplate, the at least one bushing, and the connecting rod are each independently comprised of a metal.

18. The method according to claim 12, wherein the spindle rotates at up to 3500 rpm.

19. The method according to claim 12, wherein a stroke length of the connecting rod is less than 1.5 inches.
